(19) United States
(12) Patent Application Publication
(10) Pub. No.: US 2026/0216789 A1
(43) Pub. Date: Jul. 30, 2026

(54) SYSTEMS AND METHODS FOR HIGH REACTANT CONVERSION THROUGH MULTIPLE REACTANT FLOW RATIO STAGING

(71) Applicant: Ohio State Innovation Foundation, Columbus, OH (US)

(72) Inventors: Liang-Shih Fan, Columbus, OH (US); Andrew Tong, Columbus, OH (US); Liang Zeng, Columbus, OH (US); Yitao Zhang, Columbus, OH (US); Frank Kong, Columbus, OH (US); Yu-Yen Chen, Columbus, OH (US)

(21) Appl. No.: 19/630,952

(22) Filed: Mar. 27, 2026

Related U.S. Application Data
(62) Division of application No. 18/003,457, filed on Jun. 29, 2021, now Pat. No. 12,605,764.
(60) Provisional application No. 63/045,393, filed on Jun. 29, 2020.

(51) Int. Cl. B22F 9/22; B01J 6/00; B01J 8/00; B01J 8/08; B22F 1/145

(52) U.S. Cl. CPC B22F 9/22; B01J 6/008; B01J 8/003; B01J 8/08; B22F 1/145; B01J 2208/00628; B01J 2208/00761; B22F 2201/013; B22F 2201/04; B22F 2302/25

(57) ABSTRACT

Reactor configurations may include one or more staged inlets and/or one or more staged outlets for gaseous and solid feedstocks. In one embodiment of the present disclosure, a reactor design for gas-solid reaction with one or more additional outlet for gas and/or solid phase is provided. In yet another embodiment, the design for a gas-solid reactor with one side inlet and two outlets for gas phase is described. In one embodiment, a reactor design with pairs of inlet and outlet for both gas and solid phase is provided. In another embodiment, a reactor design with one or more side inlets but only one outlet for gas phase is provided. In yet another embodiment, a reactor design with two inlets at the top/bottom of reactor and two side outlets for gaseous phase is described. In yet another embodiment, a reactor design with one or more side inlets and outlets for both gas and solid phases is provided.

### CROSS-REFERENCE TO RELATED APPLICATION(S)

The present application is a U.S. national phase stage entry of International Patent Application No. PCT/US2021/039622, filed on Jun. 29, 2021, which claims priority to U.S. Provisional Patent Application No. 63/045,393, filed on Jun. 29, 2020, the entire contents of each of which are fully incorporated herein by reference.

### FIELD

The present disclosure is related to reactor configurations for gas-solid reactions with multiple potential products to facilitate generation of one or more target products.

### INTRODUCTION

There is a continuing need for improvement of the process efficiency and product yield in chemical industry. Gas-solid reactions, whether catalytic or not, are involved in numerous industrial chemical processes for the production of solid and/or gaseous products. Currently, for reactions with intermediate products (e.g., reduction/oxidation of metal oxides where the metal has more than two valence states), the conversion of feedstock as well as the yield of target product are restricted by thermodynamic equilibrium due to the presence of only one path for the gas and solid stream in the reactors.

### SUMMARY

In one embodiment of the present disclosure, a reactor design for gas-solid reaction with one or more additional outlet for gas or solid phase is provided. In another embodiment, a reactor design for gas-solid reaction with one or more additional outlet for gas and solid phases is described. In yet another embodiment, the design for a gas-solid reactor with one side inlet and two outlets for gas phase is described. In one embodiment, a reactor design with pairs of inlet and outlet for both gas and solid phase is provided. In another embodiment, a reactor design with one or more side inlets but only one outlet for gas phase is provided. In yet another embodiment, a reactor design with two inlets at the top/bottom of reactor and two side outlets for gaseous phase is described. In yet another embodiment, a reactor design with one or more side inlets and outlets for both gas and solid phases is provided. In yet another embodiment, a modular reactor system with modules as individual reactor configurations in parallel and/or sequence is described.

The reactor configurations with staged inlets and outlets disclosed here uses side inlets and outlets on the reactor to affect conditions under thermodynamic equilibrium as well as the heat balance of reactor. In all the disclosed configurations, the reactor is designed and can be adjusted to convert gaseous and solid feedstocks to the desired product. The present disclosure details arrangements and designs for individual gas-solid reactor configurations, involving the relative flow direction of gas and solid phase, the transfer direction of O, side outlet product recycle, etc.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 shows the phase diagram of the gas-solid reaction example in this disclosure.

FIGS. 2A and 2B show the phase diagram and operating lines (represented by the lighter colored lines) of the example gas-solid reactions within a counter-current reactor.

FIGS. 3A-3H show configurations using one inlet for both the gas and solid phases and two or multiple outlets for one of the gas or solid phases.

FIGS. 4A and 4B show phase diagrams and operating lines of certain configurations shown in FIGS. 3A and 3E, respectively.

FIGS. 5A-5H show configurations using one inlet and two or multiple outlets for both the gas and solid streams.

FIGS. 6A-6D show configurations using one side inlet and two outlets at the two ends of the reactor for the gas phase.

FIGS. 7A-7H show configurations using two inlet-and-outlet pairs for the gas phase and one inlet-and-outlet pair for the solid phase.

FIGS. 8A-8H show configurations using two inlet-and-outlet pairs for the solid phase and one inlet-and-outlet pair for the gas phase.

FIGS. 9A-9D show configurations with multiple gas inlets and one gas outlet.

FIGS. 10A-10D show configurations with a gas inlet from both the top and the bottom of the reactor and gas outlet from the side.

FIGS. 11A-11D show configurations with a solid inlet from both the top and the bottom and outlet from the side.

FIGS. 12A-12D show counter-current reactor configurations with multiple side inlets and outlets for both gas and solid phases, considering the transfer direction of O and recycle of product from side outlet.

FIGS. 13A-13D show co-current reactor configurations with multiple side inlets and outlets for both gas and solid phases, considering the transfer direction of O and recycle of product from side outlet.

FIGS. 14A and 14B show a schematic layout of shaft furnace designs with and without a side outlet.

FIGS. 15A and 15B show flow diagrams of the chemical looping H₂ production system which utilizes the strategy of multiple gas phase inlets.

FIG. 16A is a schematic illustration of gas-solid contact for a conventional shaft furnace design. FIG. 16B is a schematic illustration of gas-solid contact for an exemplary shaft furnace design consistent with certain embodiments of the disclosure.

### DETAILED DESCRIPTION

Generally, systems and methods disclosed herein relate to reactor design and operation strategies that can overcome inherent thermodynamic limits, which may improve product quality and/or reduce the number of operation units. Certain objectives of gas-solid reactors can be divided into two categories: one is aiming to achieve a certain product composition of the solid, and the other one is to obtain a specific composition in the gaseous effluent. In both cases, the maximum gas-solid conversions are inherently dictated by the thermodynamics. However, for reactions with intermediate products (e.g., reduction/oxidation of metal oxides where the metal has more than two valence states) that are carried out using conventional reactors with only one path for each phase, the equilibrium composition at the product outlets might not meet the requirement to be directly collected or to be further utilized in the downstream process. To illustrate the possible nonoptimal product composition collected at the outlets for reactions with intermediate products, a four-stage gas-solid reaction carried out in a moving-bed reactor is herein used as an example throughout this disclosure.

The instant disclosure provides various operating strategies that can overcome inherent thermodynamic limitations within gas-solid reactor systems. These operating strategies can involve the use of multiple locations of injection into and/or extraction from the gas-solid reactor to circumvent the conversion limits imposed by thermodynamic equilibrium. Exemplary operating strategies may result in higher quality, purity, and/or yield of the product, and/or lower energy consumption associated with purification, compression and recycling.

Exemplary approaches can be applied to various gas-solid reactor systems, such as shaft furnace ironmaking and chemical looping H₂ production, where the conversions of both the gas and solid outlets are desired to be high but are restricted by thermodynamic equilibrium. This approach can be utilized in such systems to achieve higher gas and/or solid conversions that are not achievable in a system with one gas outlet and one solid outlet (which may result in higher product yield, energy savings, and economic benefits).

### I. Theoretical Background

Solid phases can include one or multiple metals and/or their compounds, which can include but are not limited to oxidizes, sulfides, halides, sulfates, carbonates, etc. Gas phases can include any organic or inorganic, combustible or non-combustible species, including but not limited to H₂, CO, CH₄, or a mixture thereof. The substance that is transferred between the gas and solid phases, represented by O, can be any element, including but not limited to oxygen, sulfur, nitrogen; or any compound, including but not limited to CO₂, SO₂. The gas-solid reaction can hence be redox or non-redox.

Note that in examples provided herein, compounds in the solid phases and gas phases are represented by AOₓ and BO_{X} (x≥0), respectively. However, this notation is only for the convenience of discussion. Also note that in the following discussion, the words “top” and “bottom” do not necessarily carry any meaning about the spatial orientation of the reactor. “Top” and “bottom” are used to merely indicate the flow direction of the solid phase. “Top” signifies the location where the solid phase is injected into the reactor, while “bottom” signifies the location where the solid phase leaves the reactor. The use of the two words are only for the convenience of the discussion.

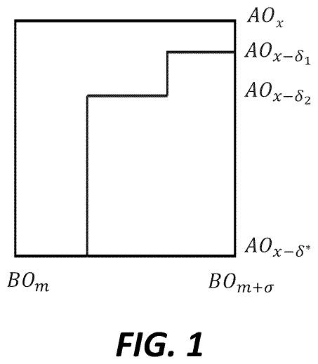

FIG. 1 presents the equilibrium phase diagram of an example gas-solid reaction where the gas and solid phases swing, respectively, from BOₘ to BO_{m+σ} and AOₓ to AO_{x-δ*}. In addition, four different valence states of A can exist in the solid phase during the reaction, which results in the following four AO compounds: AOₓ, AO_{x-δ}_{₁}, AO_{x-δ}_{₂}, and AO_{x-δ*}. The operating curves, which are derived from mass balance and are restricted by thermodynamic equilibrium, can be used to determine the gas and solids conversions.

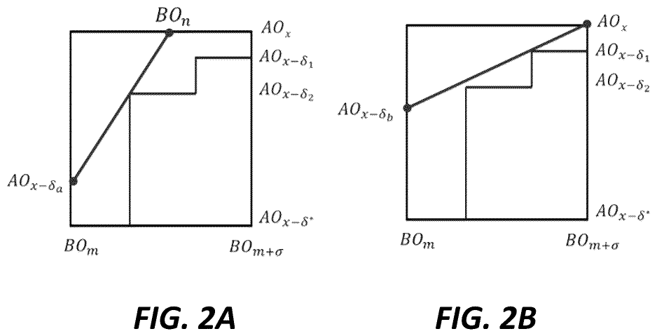

FIG. 2A illustrates a process where a specific solid composition is targeted (i.e., AO_{x-δ}_{ₐ}), in which the operating line indicates that the collected gaseous product (BOₙ) is in a mixture form of BOₘ and BO_{m+σ}. This mixture gaseous product could dramatically reduce the overall process efficiency if a pure product stream (BO_{m+σ}) is demanded, because of the requirement of adding capital-intensive air separation units and/or post-combustion units in the downstream. On the other hand, for a process that requires a pure gas product BO_{m+σ}, the corresponding solid composition at the outlet is inherently fixed at AO_{x-δb} as indicated in FIG. 2B.

If a higher conversion than AO_{x-δ}_{_{b}}, is targeted for the solid product, additional units are required to further convert the solid stream. In short, because the gas-to-solid ratio is the only adjustable parameter for such reactors under a given operating temperature and pressure, it is nearly, or completely, impossible to simultaneously achieve the gas and solid product compositions beyond what is dictated by the thermodynamic limitation. Hence, additional downstream units are required to further convert the products, thereby increasing the operating and capital cost of the process. FIG. 1 is a phase diagram of the exampled gas-solid reaction adopted in this disclosure. FIG. 2 is a phase diagram and operating lines (represented by the lighter lines) of the example gas-solid reaction within a counter-current reactor where in FIG. 2A the solid product composition is targeted at AOₓ₋ₐ, and in FIG. 2B the gas product composition is targeted at BO_{m+σ}.

### II. Example Configurations and Operational Schemes

To overcome the inherent thermodynamic limit imposed on the conventional gas-solid reactors, multiple staged injections and/or extractions strategies are provided in this disclosure. Broadly characterized, various reactor configurations are contemplated herein, and include, but are not limited to: a reactor with one inlet for the gas phase, one inlet for the solid phase, and either one of the gas or solid phases with multiple outlets, and the other phase with one outlet; a reactor with one inlet for the gas phase, one inlet for the solid phase, and multiple outlets for both the gas and the solid phases; a reactor with one inlet and one outlet for the solid phase, and one inlet for the gas phase at the side, and two outlets for the gas phase at the top and the bottom of the reactor; a reactor with multiple inlets and multiple outlets for one phase (gas or solid), and one inlet and one outlet for the other phase; a reactor with one solid inlet, one solid outlet, multiple gas inlets and one gas outlet; a reactor with the injection of one phase (gas or solid) from both the top and the bottom of the reactor; and a reactor with multiple solid inlets, multiple solid outlets, multiple gas inlets, and multiple gas outlets.

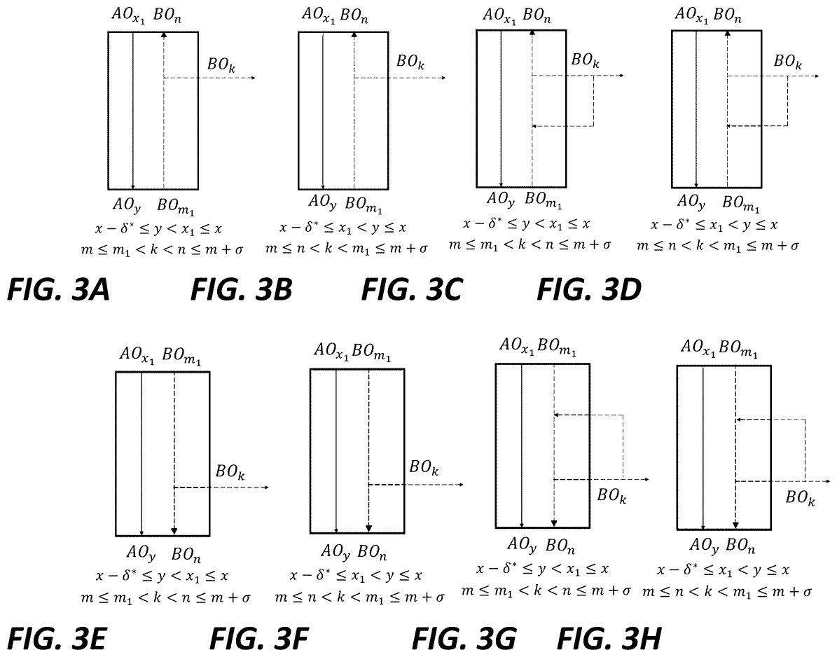

The following embodiments illustrate how these strategies may improve the process efficiency/flexibility by using two or more stages of gaseous injections/extractions. FIG. 3 shows configurations of using one inlet for both the gas and solid phases with two or multiple outlets for one phase.

In one embodiment, as shown in FIGS. 3A-3D, adding one or more reactant outlets for the gas or solid phase in a counter-current reactor, while maintaining the unmanipulated phase as a single outlet, can result in the composition of the reactants exiting one of the added outlets to be fully converted while maintaining the target conversion of the unmanipulated phase. A similar approach can be applied to co-current reactors as shown in FIGS. 3E-3H, which enables multiple outlets of the manipulated phase to have different product compositions while maintaining the product composition of the unmanipulated phase unaffected, thereby increasing the process flexibility.

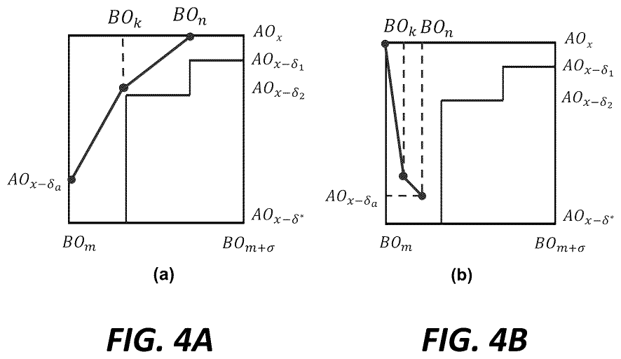

FIG. 4A schematically depicts a phase diagram for the counter-current reactor configuration of FIG. 3A. As seen, adding a side outlet creates two sections with different gas-to-solid ratios, which prevents the operating lines from intercepting the equilibrium lines. As a result, unlike the conventional reactor, where the gas composition is inherently fixed when a specific composition of the solid product is targeted as shown in FIG. 2A, an operating window for the top gas outlet (i.e., k≤n≤m+σ) can be obtained in this embodiment, including a fully converted gaseous product (BO_{m+σ}).

The rationale of applying this embodiment to co-current reactors is similar to the counter-current case, which is illustrated in FIG. 4B by using the configuration of FIG. 3E as an example. As observed, the product composition of the side outlet can be varied depending on the location of the outlet port. The principles discussed in this embodiment can be extended to the following embodiments. Note that this embodiment holds whether O is transferred from solid to gas or vice versa, and the side outlet(s) can be further recycled/reused if necessary, as depicted in FIGS. 3C, 3D, 3G, and 3H.

An exemplary application is a shaft furnace reactor for the production of direct reduced iron (DRI) from iron ore and reducing gas, commonly syngas (CO and H₂). The shaft furnace is operated as a counter-current moving bed, corresponding to the configuration shown in FIG. 3A, where pelletized iron ore is moving downward while syngas flows upward. DRI is produced at the bottom of the furnace. In this case, O stands for oxygen atom, the reactant in solid phase is iron oxide, and the reactants in gas phase are CO and H₂. The unreacted syngas coming out from the top of the furnace requires conditioning equipment, including mainly compression and CO₂ removal, to be recycled as the reducing gas of the shaft furnace or combusted to provide heat. The configuration shown in FIG. 3A can be adopted to allow one or more side outlet for the unreacted syngas. The solid to gas ratio beyond the side outlet will be higher than that below the side outlet, resulting in production of CO₂ and H₂O from full combustion of syngas. In addition, the amount of gas from the side gas outlet is less than that of gas coming out from the top of shaft furnace before the adoption of this disclosure, which reduces the size of conditioning equipment and the energy consumption of compression. Thus, the cost and energy consumption associated with CO₂ removal may be lower for the design with two gas outlets compared to one gas outlet.

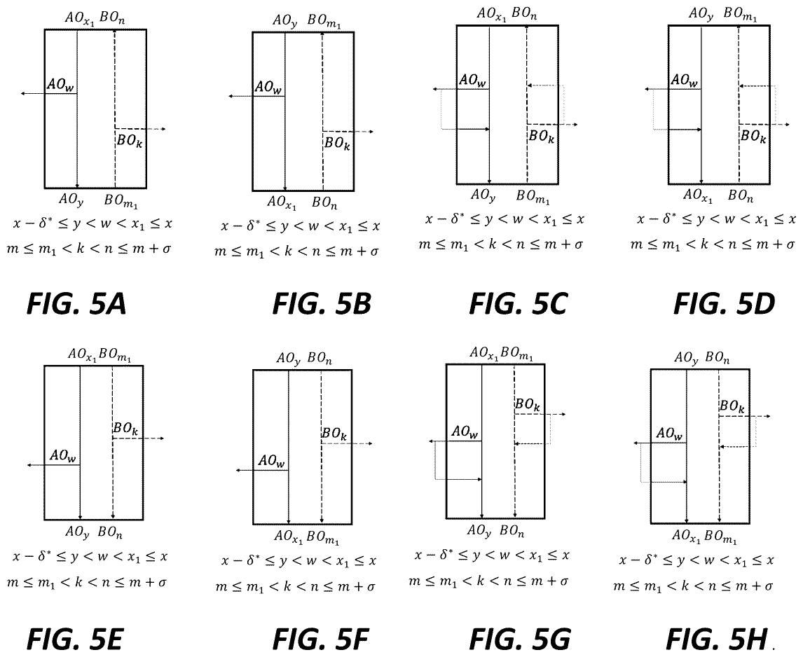

Other configurations may include reactors with side outlets for both the solid and gas streams. As shown in FIG. 5, these embodiments can be applied to reactors with counter-current or co-current gas-solid contact patterns. In addition, these embodiments hold when O is transferred from the gas phase to the solid phase or vice versa, and the effluent of the side outlets can be recycled/reused if necessary. In an extension of this embodiment, the multiple outlets can be achieved through a multi-stage moving bed reactor is connected in series where multiple outlets for the gas and/or solids can be placed between each stage. FIG. 5 shows configurations of using one inlet and two or multiple outlets for both the gas and solid streams.

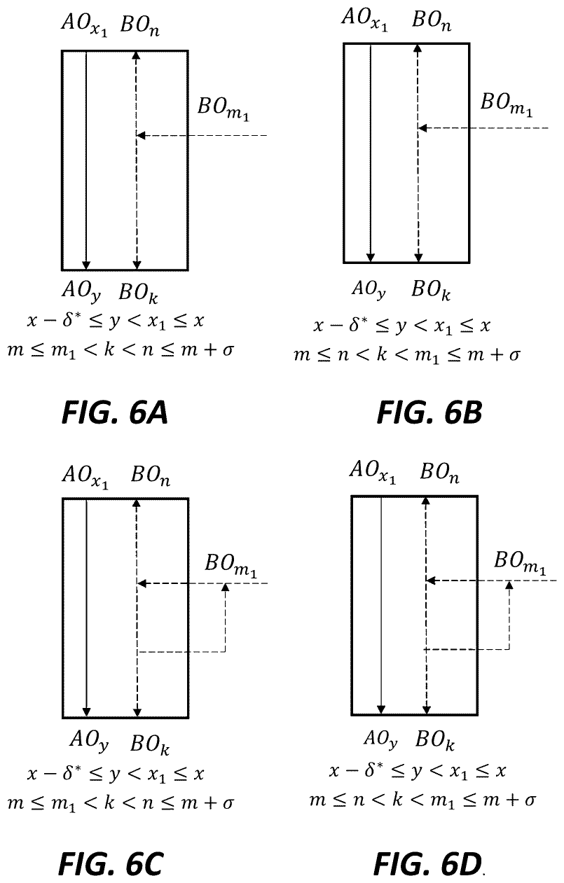

FIGS. 6A-6D show configurations of using one side inlet, one top and bottom outlets for the gas phase. As shown in FIGS. 6A-6D, the gas inlet is introduced to the side of the reactor, resulting the gas stream split into two outlets respectively at the top and the bottom of the reactor as exemplified in FIGS. 6A and 6B. Through this configuration, counter-current and a co-current gas-solid contacts can be created at different sections within the reactor. Thus, the gas product composition of the counter-current section can be varied, including a fully converted gaseous product (BOₘ₊₆). This embodiment holds whether O is transferred from the solid to the gas phase or vice versa. If necessary, the gaseous effluent of the co-current contact section, which is a mixture of BOₘ and BO_{m+σ}, can be further recycled/reused as shown in FIGS. 6C and 6D.

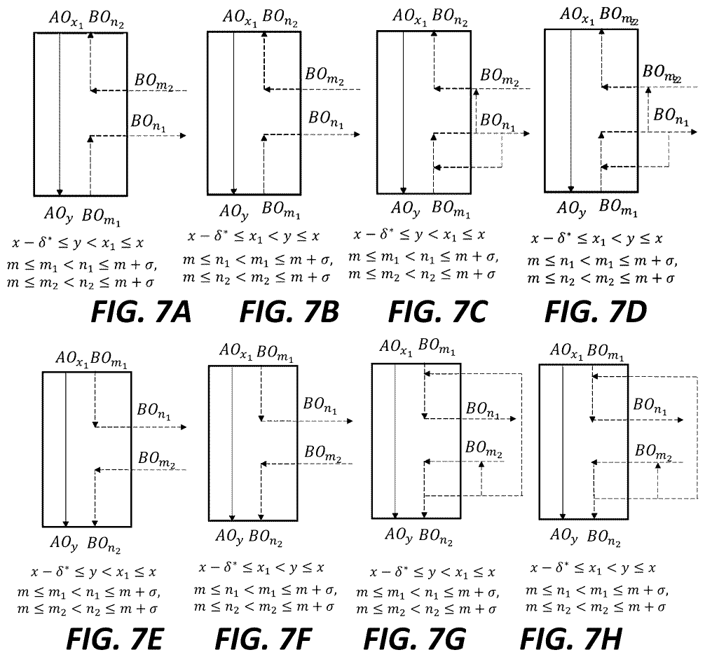

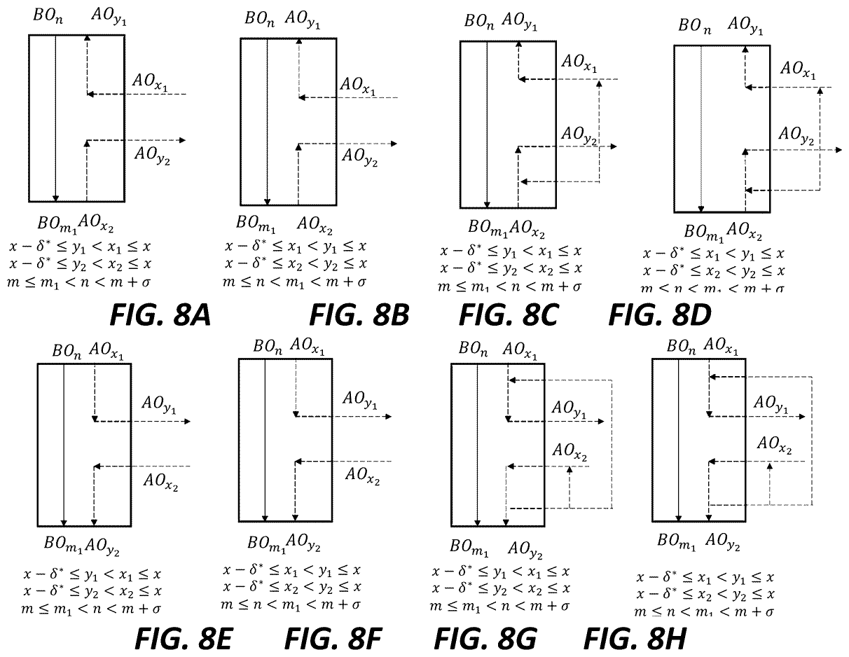

In other embodiments, two inlet-and-outlet pairs are designed for one phase while the other phase remains with one inlet-and-outlet pair. FIGS. 7A-7H show configurations of using two inlet-and-outlet pairs for the gas phase and one inlet-and-outlet pair for the solid phase. FIGS. 8A-8H show configurations of using two inlet-and-outlet pairs for the solid phase and one inlet-and-outlet pair for the gas phase. For the phase with two inlet-and-outlet pairs, the inlet and outlet of one pair are located respectively at one end and side of the reactor, whereas the other pair has the opposite order. Through this design, a counter-current and a co-current gas-solid contacts can be created at different sections within a counter-current reactor, while two co-current sections with different gas-to-solid ratio can be obtained in a co-current reactor. These configurations hold whether O is transferred from the solid to the gas phase or vice versa. If necessary, the outlet streams of the phase with two pairs of inlet and outlet can be further recycled/reused.

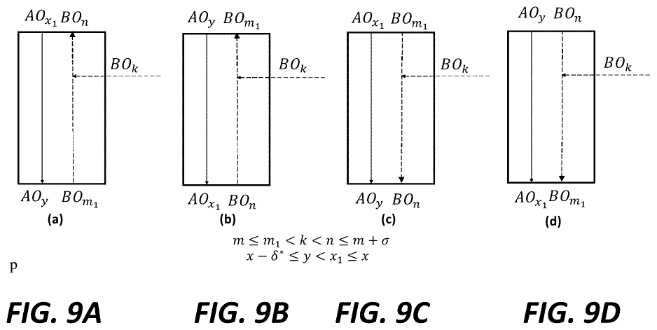

FIGS. 9A-9D show four exemplary arrangements of the gas and solid flow of the system where the reactor is operated with a solid inlet and a gas inlet, which flow in either a counter-current or co-current pattern. The solid inlet stream is injected from the top of the reactor and leaves the reactor at the bottom. The gas inlet is injected from the bottom of the bed in the counter-current operating mode and is injected from the top of the bed in the co-current operating mode. An additional gas stream or multiple gas streams are injected from the side of the reactor. FIG. 9A shows the configuration where the solid and gas react in a counter-current contact pattern where O is transferred from the solid to the gas. FIG. 9B shows another configuration with counter-current gas-solid flow pattern where O is transferred from the gas to the solid. FIGS. 9C and 9D show the configurations where the solid and gas flow in a co-current contact pattern. In FIG. 9C, O is transferred from the solid to the gas. In FIG. 9D, O is transferred from the gas to the solid.

A specific application of embodiments shown in FIGS. 9A-9D is in the reducer operation of chemical looping H₂ production. The reducer of the chemical looping H₂ production process corresponds to FIG. 9A, which operates under a counter-current gas-solid contact pattern, where the solid is reduced and the gas is oxidized. In this specific case, O stands for oxygen atoms. An objective of the reducer of the chemical looping H₂ production process is to fully oxidize one or multiple reducing gas streams into CO₂ and H₂O, while reducing the metal oxide to an oxidation degree sufficiently low in order to facilitate the subsequent water splitting reaction in the oxidizer. When more than one gas streams of different compositions are used as the reactants, multiple stages of reactant gas injection along the height of the reactor can provide greater efficiency benefit than from one point at the bottom of the reactor. The design shown in FIG. 9A can be adopted to let one or several gas streams to be injected from the side of the reducer. The gas streams injected from the side are usually those with lower reducing potential. This configuration can result in a degree of solid reduction at the reducer bottom solid outlet that is higher than the case when all the gas streams are injected from the bottom of the reducer, while fully oxidizing the gaseous reactants into H₂O and CO₂.

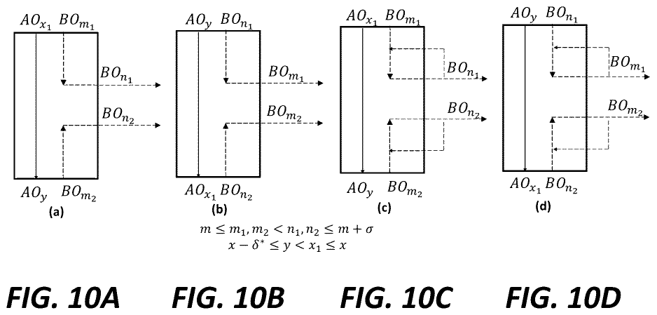

FIGS. 10A-10D show configurations of gas inlets being provided from both the top and the bottom, with multiple side outlets. In FIG. 10A-10D, either the gas or the solid inlet is injected from both the top and the bottom of the reactor. FIGS. 10A-10D show the system design where the solid enters the reactor from the top and leaves the reactor from the bottom, while the gas is injected from both the top and the bottom of the reactor. FIG. 10A shows a configuration where O is transferred from the solid to the gas. FIG. 10B shows a configuration where O is transferred from the gas to the solid. The systems shown in FIGS. 10C and 10D are constructed by applying gas recycle to the configurations shown in FIGS. 10A and 10B, respectively. Although FIGS. 10C and 10D show the system configurations where both gas outlets are recycled, in practical operation it is possible to only recycle one of the two gas outlet streams.

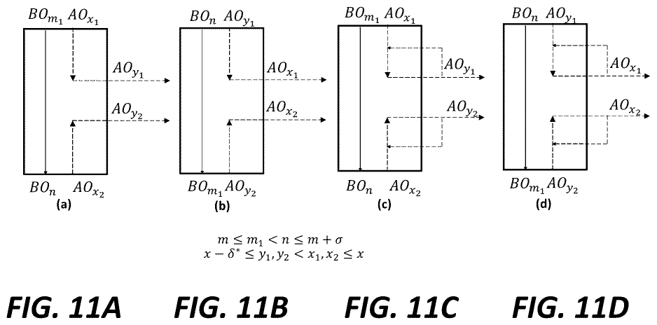

FIGS. 11A-11D show configurations where solids are injected both from the top and the bottom of the reactor, while the gas is injected from the top and flows downward. FIG. 11A shows a configuration where the gas stream, which is injected from the top of the reactor, receives O transferred from the solid. FIG. 11B shows the system design where O is transferred from the gas to the solid. FIGS. 11C and 11D are constructed by applying solid recycle to the configurations shown in FIGS. 11A and 11B, respectively. Although FIGS. 11C and 11D show system configurations where both solid outlets are recycled, in practical operation it is possible to only recycle one of the two solid outlet streams.

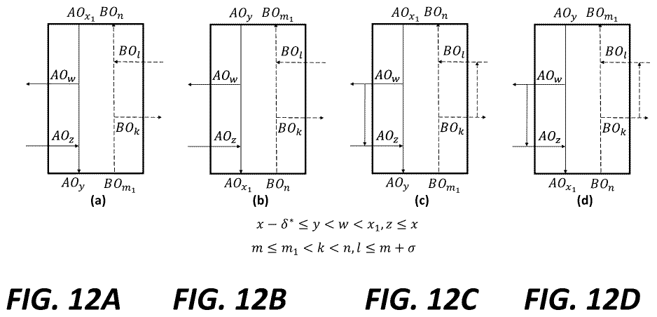

FIGS. 12A-12D show configurations of one side inlet and one side outlet for both gas and solid phases in a counter-current reactor. An example shown in FIG. 12A includes one side inlet and one side outlet are included for both gas and solid phases in a counter-current reactor. It is noted that O is transferred from solid to gas in FIG. 12A and can be transferred from gas to solid as shown in FIG. 12B. The side inlets and outlets enable the operation to make use of multiple valence states of the solid material and to facilitate the production of one or more target product from the reactor. Summarized in FIGS. 12C and 12D, the product from the side outlets (AO_{w} and BOₖ) can be recycled back to the reactor with or without treatment, which affects the composition of stream for side inlet as well as the heat balance of the reactor. In addition, the layouts of FIGS. 12C and 12D are valid if only one of the side outlet products (AO_{w} and BO_{K}) is recycled.

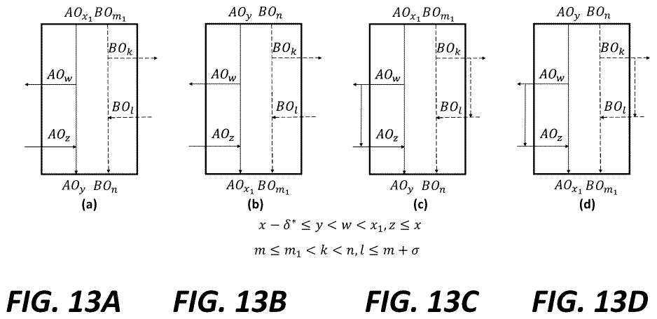

FIGS. 13A-13D show configurations of one side inlet and one side outlet for both gas and solid phases in a co-current reactor. As shown in FIG. 13A, one or more inlets and outlets for both gas and solid phases can be included in a co-current reactor. O is transferred from solid to gas in FIG. 13A and can be transferred from gas to solid as shown in FIG. 13B. In some instances, part or all of side outlet products AO_{w} and BOₖ can be recycled to the reactor with or without treatment as shown in FIGS. 13C and 13D. Configurations shown in FIGS. 13C and 13D may result in additional flexibility for heat balance of the reactor and the quality of target product. It is noted that the recycle of side outlet product can be AO_{w} and/or BOₖ.

In all embodiments, multiple modules can be arranged in parallel and/or sequence to form a modular reactor system. The modules are chosen from all the reactor configurations above, thus improving the flexibility and quality of product compared to individual reactor.

### III. Example Methods of Operation

Various methods may be employed to operate the various reactor system configurations disclosed and contemplated herein.

An exemplary method may include providing, in a first flow direction, metal particles to a solids inlet of the reactor. The metal particles have at least two oxidation states and enter the solids inlet at a first oxidation state. In some instances, the metal particles comprise iron ore, and other contemplated materials are discussed in greater detail elsewhere in this disclosure.

The example method may also include providing, in a second flow direction, an inlet gas stream to a first gas inlet of the reactor such that the first flow direction and the second flow direction are counter current. In some instances, the inlet gas stream comprises carbon monoxide (CO) and hydrogen (H₂).

The method also includes providing a first gas outlet stream via a first gas outlet arranged near a top of the reactor. The first gas outlet may be positioned such that the first gas outlet stream comprises a minimum amount of carbon in the form of carbon dioxide (CO₂). For instance, 85-98%; 88-96%; 90-98%; 90-95%; or 95-98% of carbon in the first gas outlet stream may be in the form of carbon dioxide (CO₂). In various implementations, at least 85%; at least 88%; at least 90%; at least 92%; at least 95%; or at least 98% of carbon in the first gas outlet stream may be in the form of carbon dioxide (CO₂). In various implementations, no more than 99%; no more than 98%; no more than 96%; no more than 95%; no more than 90%; or no more than 85% of carbon in the first gas outlet stream may be in the form of carbon dioxide (CO₂).

The method may also include providing a second gas outlet stream via a second gas outlet positioned below the first gas outlet. In some instances, the second gas outlet stream may be recycled and provided back to the reactor. For countercurrent flow configurations, the recycle stream may be provided at a position lower than the second gas outlet. For co-current flow configurations, the recycle stream may be provided at a position higher than the second gas outlet.

Various extraction ratios may be used to draw off the second gas outlet stream, where the extraction ratio is a percentage of the gas stream exiting the second gas outlet. Extraction ratios may depend on an amount of oxygen (O₂) in the gas stream. For instance, an extraction ratio for the second gas outlet stream may be 60%-75%; 62%-72%; 60%-65%; or 70%-75%. In various implementations, an extraction ratio for the second gas outlet stream may be at least 60%; at least 62%; at least 65%; at least 67%; at least 70%; at least 72%; or at least 74%. In various implementations, an extraction ratio for the second gas outlet stream may be no more than 75%; no more than 73%; no more than 70%; no more than 68%; no more than 64%; or no more than 62%.

The example method may include discharging metal particles via a solids outlet positioned proximate a bottom portion of the reactor. The discharged metal particles are at a second oxidation state that is different from the first oxidation state. Additionally, the metal particles comprise less oxygen at the solids outlet than directly below the second gas outlet.

In some instances, the example method may include discharging metal particles via a second solids outlet. The second solids outlet may be positioned at a side of the reactor and above the bottom of the reactor. Metal particles discharged at the solids outlet (proximate the bottom of the reactor) comprise less oxygen than the metal particles discharged at the second solids outlet higher in the reactor. In countercurrent configurations, the second solids outlet may be positioned relatively higher in the reactor than the second gas outlet. In co-current configurations, the second solids outlet may be positioned relatively lower in the reactor than the second gas outlet.

In some instances, the example method may include providing the inlet gas stream at a side of the reactor such that a portion of the inlet gas flows counter-currently to the metal particles and a remaining portion of the inlet gas flows co-currently with the metal particles. In those implementations, the method may comprise providing a first gas outlet stream at a top of the reactor and providing a second gas outlet stream at a bottom of the reactor.

Another exemplary method may include providing, in a first flow direction, metal particles to a solids inlet of the reactor. The metal particles have at least two oxidation states and enter the solids inlet at a first oxidation state. In some instances, the metal particles comprise iron oxide particles.

The example method may also include providing, in a second flow direction, a first inlet gas stream to a first gas inlet and a second inlet gas stream to a second gas inlet of the reactor. The first inlet gas stream and the second inlet gas stream may be provided such that the first flow direction and the second flow direction are counter current. The second gas inlet may be provided closer to a top of the reactor than the first gas inlet.

In some instances, each of the first inlet gas stream and the second inlet gas stream comprise carbon dioxide (CO₂), carbon monoxide (CO), hydrogen (H₂), or combinations thereof. In some instances, the first inlet gas stream and the second inlet gas may have different compositions. For example, the first inlet gas stream may have a composition with a reducing potential that is greater than a reducing potential of a composition provided to the second inlet gas stream.

The method also includes providing a first gas outlet stream via a first gas outlet arranged near a top of the reactor. The first gas outlet may be positioned such that the first gas outlet stream comprises a minimum amount of carbon in the form of carbon dioxide (CO₂). For instance, 85-98%; 88-96%; 90-98%; 90-95%; or 95-98% of carbon in the first gas outlet stream may be in the form of carbon dioxide (CO₂). In various implementations, at least 85%; at least 88%; at least 90%; at least 92%; at least 95%; or at least 98% of carbon in the first gas outlet stream may be in the form of carbon dioxide (CO₂). In various implementations, no more than 99%; no more than 98%; no more than 96%; no more than 95%; no more than 90%; or no more than 85% of carbon in the first gas outlet stream may be in the form of carbon dioxide (CO₂).

In some instances, the method may also include providing a second gas outlet stream via a second gas outlet positioned below the first gas outlet. In some instances, the second gas outlet stream may be recycled and provided back to the reactor. For countercurrent flow configurations, the recycle stream may be provided at a position lower than the second gas outlet. For co-current flow configurations, the recycle stream may be provided at a position higher than the second gas outlet.

Various extraction ratios may be used to draw off the second gas outlet stream, where the extraction ratio is a percentage of the gas stream exiting the second gas outlet. Extraction ratios may depend on an amount of oxygen (O₂) in the gas stream. For instance, an extraction ratio for the second gas outlet stream may be 60%-75%; 62%-72%; 60%-65%; or 70%-75%. In various implementations, an extraction ratio for the second gas outlet stream may be at least 60%; at least 62%; at least 65%; at least 67%; at least 70%; at least 72%; or at least 74%. In various implementations, an extraction ratio for the second gas outlet stream may be no more than 75%; no more than 73%; no more than 70%; no more than 68%; no more than 64%; or no more than 62%.

The example method may include discharging metal particles via a solids outlet positioned proximate a bottom portion of the reactor. The discharged metal particles are at a second oxidation state that is different from the first oxidation state. Additionally, the metal particles comprise less oxygen at the solids outlet than directly below the second gas outlet.

In some instances, the example method may include discharging metal oxide particles from a second solids outlet. The second solids outlet may be arranged at a side of the reactor and above the bottom of the reactor.

### IV. Experimental Examples

Two experimental cases are studied as examples to quantitatively show the benefit of reactor configurations in this disclosure. One case is on pyrometallurgy and the other one is on hydrogen production. The thermodynamic calculation results of the cases are obtained using Aspen Plus and shown below.

### A. Pyrometallurgy

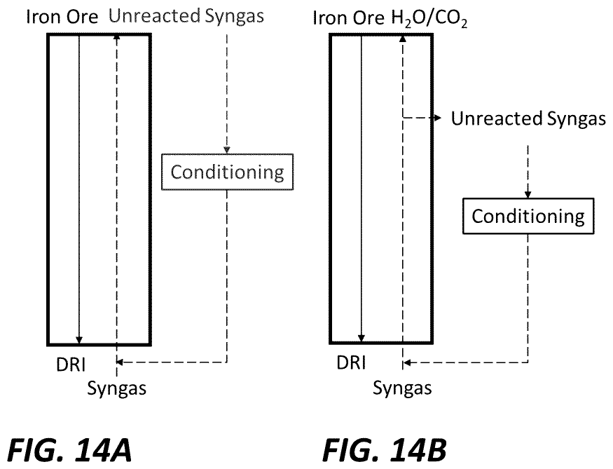

One case considers the production of direct reduced iron (DRI) from iron ore and reducing gas, which is usually syngas, in a shaft furnace. Table 1 shows the composition of iron ore and syngas used in calculation (reference ORNL/TM-2005). FIGS. 14A and 14B show a shaft furnace for DRI production: FIG. 14A shows one gas outlet and FIG. 14B shows two gas outlets. As is shown in FIG. 14A, the shaft furnace is operated as a counter-current moving bed, where pelletized iron ore is moving downward and syngas is flowing upward. DRI is produced at the bottom of the furnace. The unreacted syngas coming out from the top of the furnace requires conditioning equipment, including mainly compression and CO₂ removal, to be recycled as the reducing gas of the shaft furnace or combusted to provide heat.

For the design of shaft furnace, application of this disclosure will reduce the cost and energy required for the conditioning equipment. FIG. 14B shows the shaft furnace with two gas outlets. From the side gas outlet, the amount of gas is less than that of gas coming out from the top of shaft furnace in FIG. 14A, which reduces the size of conditioning equipment and the energy consumption of compression. Besides, part of the CO₂ is inherently removed by the configuration with two gas outlets and coming out from the top gas outlet. Thus, the cost and energy consumption associated with CO₂ removal is lower for the configuration with two gas outlets compared to one gas outlet.

TABLE 1
Composition of iron ore and syngas (in weight percentage)

| | Syngas | | Iron Ore |
|---|---|---|---|
| CH₄ | 8.8 | Fe₂O₃ | 82 |
| CO | 64.1 | Fe₃O₄ | 12 |
| CO₂ | 12.7 | SiO₂ | 6 |
| H₂ | 5.7 | | |
| H₂O | 8.2 | | |
| N₂ | 0.5 | | |

Based on the composition given in Table 1, production of 1 kg DRI needs 0.73 kg syngas for both configurations shown in FIGS. 14A and 14B. Table 2 summarizes the composition of gas coming out from shaft furnace. The volume of product from side gas outlet in two gas outlets configuration is 85% of the top gas output in one gas outlet configuration, which results in a 15% saving of energy consumption as well as the equipment size for compression. Calculation also shows that the two gas outlets configuration reduces 33% energy consumption for CO₂ removal compared to the one gas outlet configuration.

TABLE 2
Gas outlet composition for the production of 1 kg DRI (Unit: kg)

| | |
|---|---|
| One Gas Outlets | Two Gas Outlets |

| | Top | Top | Side |
|---|---|---|---|
| CH₄ | 0.000 | 0.000 | 0.000 |
| CO | 0.359 | 0.000 | 0.354 |
| CO₂ | 0.431 | 0.149 | 0.290 |
| H₂ | 0.032 | 0.000 | 0.032 |
| H₂O | 0.286 | 0.086 | 0.197 |
| N₂ | 0.004 | 0.001 | 0.003 |

### B. Hydrogen Production

The advantage of the staged-injection configuration is quantified by another case study, which is concerned about the H₂ production from a chemical looping system. This case study considers the production of H₂ using two gas streams as the feedstock in a chemical looping system. These two gas streams include a stream of natural gas and a stream of low-quality tail gas. The compositions of the two streams are shown in Table 3.

TABLE 3
Composition (shown in molar fraction)
of gas streams used in the case study

| | Natural Gas | Tail Gas |
|---|---|---|
| CH₄ | 0.931 | 0 |
| C₂H₆ | 0.032 | 0 |
| C₃H₈ | 0.007 | 0 |
| C₄H₁₀ | 0.004 | 0 |
| CH₃OH | 0 | 0 |
| CO₂ | 0.01 | 0.62 |
| CO | 0 | 0.19 |
| H₂ | 0 | 0.19 |
| N₂ | 0.016 | 0 |

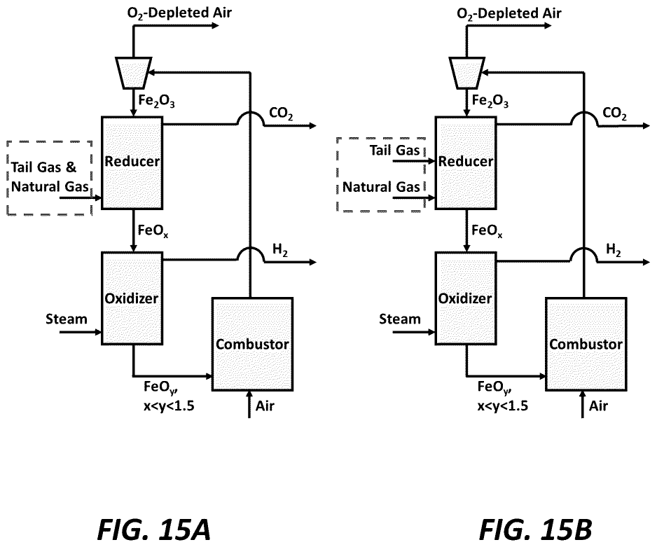

As indicated by the compositions in Table 3, natural gas is a strongly reducing gas mixture because it mainly contains hydrocarbons and has minimal amount of CO₂. On the other hand, the tail gas stream is much less reducing because it contains high concentration of CO₂. Based on thermodynamic rationale, utilizing the two gases in the staged injection system is expected to show added benefits compared to injecting the two gases from the same port. Two cases have been simulated in ASPEN Plus v11, including one case of single port injection and one case of staged injection, to quantify the additional benefits of the staged injection strategy. The flow diagrams of the two cases are shown in FIGS. 15A and 15B. This operating strategy corresponds to the system configuration shown in FIG. 10A. FIGS. 15A and 15B show flow diagrams of a single port injection case (FIG. 15A) and a staged injection case (FIG. 15B).

As shown in FIG. 15A, for the single port injection case, natural gas and tail gas are both injected from the bottom of the reducer. Whereas for the staged injection case, natural gas is injected from the bottom of the reducer while tail gas is injected from the side of the reducer.

The performance of the two cases is summarized in Table 4. The molar flows of feedstock and products of this study are normalized based on 1 kmol/hr natural gas injection into the reducer.

TABLE 4
Plant performance of the single port injection
and staged injection cases

| | |
|---|---|
| Single Port | Staged |
| Injection | Injection |

Input Conditions

| | | |
|---|---|---|
| Tail Gas Inlet, kmol/hr | 6.9 | 6.9 |
| Natural Gas Inlet, kmol/hr | 1 | 1 |
| Oxidizer Steam Inlet, kmol/hr | 14.6 | 9.2 |
| Solid Circulation Rate, kg/hr | 3468 | 2603 |

Output Conditions

| | | |
|---|---|---|
| Reducer Bottom Solid | 34.1 | 45.4 |
| Conversion*, % | | |
| H2 Output, kmol/hr | 3.52 | 4.09 |

$$* Solid Conversion = \frac{lattice oxygen removed from the particles}{total available lattice oxygen from the particles} = 1 - \frac{[ O ] / [ Fe ]}{1.5}$$

As shown in Table 4, both systems operate with a tail gas/natural gas feedstock molar ratio of 6.9. The operating conditions of both systems are adjusted to maximize H₂ yield while maintaining the solid temperature balance of the chemical looping system. The comparison between the two cases indicate that the staged injection option has significant advantages compared to the single port injection option in multiple aspects, including higher H₂ yield, less steam consumption, and lower solid circulation rate. The staged injection case is able to generate 16.4% more H₂ than the single port injection case using the same feedstock. In addition, the steam consumption of the staged injection case is 36.8% lower than the single stage injection case. Moreover, the solid circulation rate of the staged injection case is 24.9% lower than the single stage system, which leads to significant reduction in reactor size.

A reason for the various benefits of the staged injection case is the change in thermodynamics inside the reducer induced by the change in the locations of feedstock injection. By injecting the more reducing natural gas separately from the bottom while injecting the less reducing tail gas from the side, the metal oxide particles are exposed to a more reducing environment at the bottom of the reducer compared to the single port injection mode. The more reducing environment at the reducer bottom enables the reduction of particles into a lower oxidation state, as indicated by the comparison between the solid conversion of the two cases. While the single port injection case can reduce the particles to a maximum solid conversion of 34.1%, the staged injection case can reduce the particles to a maximum solid conversion of 45.4%. Higher solid conversion means that more H₂ can be produced from the oxidizer using less steam, as previously indicated in Table 4.

### C. Reduction of Iron Ore Experiments

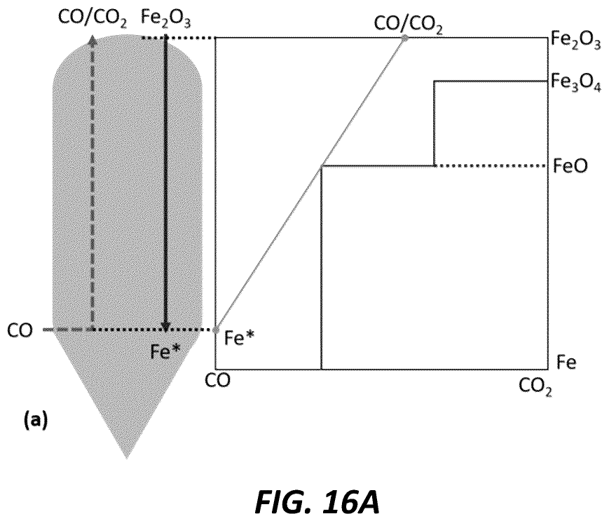

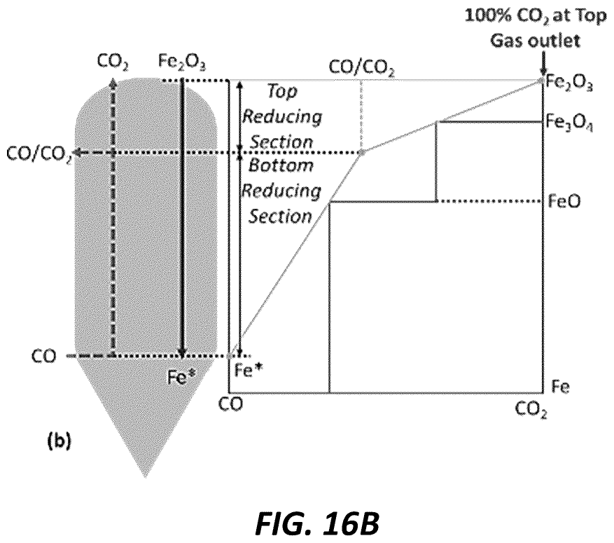

Experiments were performed that evaluated the reduction of iron ore by selectively varying the reducing-gas-to-iron-ore flow ratio. The location of the gas inlets and outlets are placed on the shaft reactor to thermodynamically optimize the reduction of iron ore and the conversion of the reducing gas to CO₂. The equilibrium phase diagram and operating line for a conventional shaft furnace under isothermal conditions are illustrated in FIG. 16A using CO as the example of reducing agent. Similar to a Rist diagram used for blast furnace design, the operating line is derived from mass balance and is restricted by thermodynamic equilibrium constraints and can be used to determine the maximum gas and solids conversions attainable based on the desired product.

In the case of a single gas outlet, to reach a desired metallic iron content (Fe*), a high CO content ratio product gas from the shaft furnace will be produced. Incorporating a secondary gas outlet side extraction from the shaft furnace changes the reducing gas and iron flow ratio, and, by adjusting the amount of gas extracted from each outlet, a fully oxidized gas stream including predominantly CO₂ and H₂O can be extracted from the top section of the reactor, as indicated in FIG. 16B.

The reduction of iron oxides with CO in a counter-current moving-bed reactor was simulated and validated experimentally. In the bench scale reactor experiment, iron titanate (Fe₂TiO₅) was reduced by CO under varying side port extraction flow rates. As shown in Table 5 below, the CO conversion at the top of the reactor increased significantly as the side extraction ratio, defined as the ratio between the side extraction flow rate and the total gas flow rate in the bottom section of the reactor, increased.

TABLE 5
The comparison of simulation and experimental results of gas outlet
composition for various side port gasextraction fraction of MSF

| | Side extraction ratio | | | |
|---|---|---|---|---|
| Outlet Gas | 62% | | 72% | |
| Concentration | Experiment | Simulation | Experiment | Simulation |
| CO₂ (%) | 95 | 96 | 98 | 100 |
| CO (%) | 5 | 4 | 2 | 0 |

The reducing gas was almost fully oxidized to CO₂ as the side extraction ratio reaches 72%. The results are consistent with the prediction of ASPEN process simulation. This experiment demonstrated that the full oxidation of reducing gas in the reactor can be achieved via manipulating the side extraction, and that the ASPEN process model can be used to predict the performance of the reactor. Note, without the side extraction, the CO concentration in the gas outlet will reach up to 44%, requiring a CO₂ separation device to purify the stream. The incomplete iron conversion (63%) was only due to the limitations of the existing flowmeters on the existing moving bed bench unit. As the simulations match well with the experimental results, the testing proves the side extraction design allows for CO₂ capture from the moving bed shaft furnace will produce reduced iron.

### V. Embodiments

Embodiments of the present disclosure are disclosed in the following clauses:
Clause 1. A method for operating a reactor having a top and a bottom, the method comprising:
   providing, in a first flow direction, metal particles to a solids inlet of the reactor,
      wherein the metal particles have at least two oxidation states; and
      wherein the metal particles enter the solids inlet at a first oxidation state;
   providing, in a second flow direction, an inlet gas stream to a gas inlet of the reactor, such that the first flow direction and the second flow direction are counter-current;
   providing a first gas outlet stream via a first gas outlet arranged proximate a top of the reactor,
      wherein at least 85% of carbon species in the first gas outlet stream is in the form of carbon dioxide (CO₂);
   providing a second gas outlet stream via a second gas outlet positioned below the first gas outlet; and
   discharging metal particles via a solids outlet positioned proximate a bottom portion of the reactor, the metal particles being at a second oxidation state that is different from the first oxidation state,
   wherein the metal particles comprise less oxygen at the solids outlet than directly below the second gas outlet.
Clause 2. The method according to clause 1, further comprising recycling the second gas outlet stream at a position in the reactor that is relatively higher than the second gas outlet.
Clause 3. The method according to clause 1 or clause 2, further comprising:
   discharging metal particles via a second solids outlet arranged at a side of the reactor and above the bottom of the reactor,
   wherein the metal particles discharged at the solids outlet comprise less oxygen than the metal particles discharged at the second solids outlet.
Clause 4. The method according to any one of clauses 1-3, the metal particles being discharged through the second solids outlet at a position that is relatively higher in the reactor than the second gas outlet.
Clause 5. The method according to clause 4, further comprising recycling the metal particles discharged through the second solids outlet back through a second solids inlet positioned lower in the reactor than the second solids outlet.
Clause 6. The method according to any one of clauses 1-5, further comprising providing the inlet gas stream in the first flow direction such that a portion of the inlet gas stream flows co-currently with the metal particles.
Clause 7. The method according to clause 6, wherein the gas inlet of the reactor is positioned at a side of the reactor positioned below the top of the reactor.
Clause 8. The method according to any one of clauses 1-7, wherein the gas inlet of the reactor is positioned at the bottom of the reactor.
Clause 9. The method according to clause 8, further comprising providing a second gas inlet stream via a second gas inlet, the second gas inlet being positioned relatively higher in the reactor than the second gas outlet.
Clause 10. The method according to clause 9, further comprising recycling a portion of the second gas outlet stream back through the second gas inlet.
Clause 11. The method according to any one of clauses 1-10, wherein 60-75% of the inlet gas stream is provided in the first gas outlet stream.
Clause 12. The method according to any one of clauses 1-11, wherein at least 95% of carbon species in the first gas outlet stream is carbon dioxide (CO₂).
Clause 13. The method according to any one of clauses 1-12, wherein the metal particles comprise iron ore.
Clause 14. The method according to any one of clauses 1-13, wherein the inlet gas stream comprises carbon monoxide (CO) and hydrogen (H₂).
Clause 15. A method for operating a reactor having a top and a bottom, the method comprising:
providing, in a first flow direction, metal oxide particles to a solids inlet of the reactor,
   where the metal oxide particles have at least two oxidation states; and
   wherein the metal oxide particles enter the solids inlet at a first oxidation state;
providing, in a second flow direction, a first inlet gas stream to a first gas inlet proximate the bottom of the reactor, such that the first flow direction and the second flow direction are counter-current,
providing a second inlet gas stream in the second flow direction to a second gas inlet of the reactor, the second gas inlet positioned closer to a top of the reactor than the first gas inlet;
providing a gas outlet stream via a gas outlet arranged near the top of the reactor,
   wherein the metal oxide particles below the second gas inlet comprise more oxygen than the metal oxide particles below the first gas inlet.
   wherein at least 85% of carbon in the first gas outlet stream being in the form of carbon dioxide (CO₂); and
discharging metal particles via a solids outlet positioned proximate a bottom portion of the reactor, the metal particles being at a second oxidation state that is different from the first oxidation state.
Clause 16. The method according to clause 15, further comprising discharging metal oxide particles via a second solids outlet arranged at a side of the reactor and above the bottom of the reactor.
Clause 17. The method according to clause 15 or clause 16, wherein the metal oxide particles are iron oxide particles; and
wherein the second gas inlet stream comprises carbon dioxide (CO₂), carbon monoxide (CO), and hydrogen (H₂).
Clause 18. A reactor in a chemical looping system, the reactor comprising:
a solids inlet arranged to provide metal oxide particles in a first flow direction,
   where the metal oxide particles have at least two oxidation states; and
   wherein the metal oxide particles enter the solids inlet at a first oxidation state;
a first gas inlet arranged to provide an inlet gas stream in a second flow direction such that the first flow direction and the second flow direction are counter-current,
   the first gas inlet positioned near a bottom of the reactor;
a second gas inlet arranged to provide a gas stream in the second flow direction,
   the second gas inlet positioned closer to a top of the reactor than the first gas inlet;
a gas outlet arranged near the top of the reactor and configured to provide a gas outlet stream,
   wherein the metal oxide particles below the second gas inlet comprise more oxygen than the metal oxide particles below the first gas inlet.
   wherein at least 85% of carbon in the first gas outlet stream being in the form of carbon dioxide (CO₂); and
a solids outlet positioned near the bottom of the reactor and configured to provide metal oxide particles at a second oxidation state that is different from the first oxidation state.
Clause 19. The reactor according to clause 18, wherein the metal oxide particles are iron oxide particles.
Clause 20. The reactor according to clause 18 or clause 19, wherein the second gas inlet stream comprises carbon dioxide (CO₂), carbon monoxide (CO), and hydrogen (H₂).

1-14. (canceled)

15. A method for operating a reactor having a top and a bottom, the method comprising:
providing, in a first flow direction, metal oxide particles to a solids inlet of the reactor,
where the metal oxide particles have at least two oxidation states; and
wherein the metal oxide particles enter the solids inlet at a first oxidation state;
providing, in a second flow direction, a first inlet gas stream to a first gas inlet proximate the bottom of the reactor, such that the first flow direction and the second flow direction are counter-current,
providing a second inlet gas stream in the second flow direction to a second gas inlet of the reactor, the second gas inlet positioned closer to a top of the reactor than the first gas inlet;
providing a gas outlet stream via a gas outlet arranged near the top of the reactor,
wherein the metal oxide particles below the second gas inlet comprise more oxygen than the metal oxide particles below the first gas inlet,
wherein at least 85% of carbon in the first gas outlet stream being in the form of carbon dioxide (CO₂); and
discharging metal particles via a solids outlet positioned proximate a bottom portion of the reactor, the metal particles being at a second oxidation state that is different from the first oxidation state.

16. The method according to claim 15, further comprising discharging metal oxide particles via a second solids outlet arranged at a side of the reactor and above the bottom of the reactor.

17. The method according to claim 15, wherein the metal oxide particles are iron oxide particles; and
wherein the second gas inlet stream comprises carbon dioxide (CO₂), carbon monoxide (CO), and hydrogen (H₂).

18. A reactor in a chemical looping system, the reactor comprising:
a solids inlet arranged to provide metal oxide particles in a first flow direction,
where the metal oxide particles have at least two oxidation states; and
wherein the metal oxide particles enter the solids inlet at a first oxidation state;
a first gas inlet arranged to provide an inlet gas stream in a second flow direction such that the first flow direction and the second flow direction are counter-current,
the first gas inlet positioned near a bottom of the reactor;
a second gas inlet arranged to provide a gas stream in the second flow direction,
the second gas inlet positioned closer to a top of the reactor than the first gas inlet;
a gas outlet arranged near the top of the reactor and configured to provide a gas outlet stream,
wherein the metal oxide particles below the second gas inlet comprise more oxygen than the metal oxide particles below the first gas inlet,
wherein at least 85% of carbon in the first gas outlet stream being in the form of carbon dioxide (CO₂); and
a solids outlet positioned near the bottom of the reactor and configured to provide metal oxide particles at a second oxidation state that is different from the first oxidation state.

19. The reactor according to claim 18, wherein the metal oxide particles are iron oxide particles.

20. The reactor according to claim 19, wherein the second gas inlet stream comprises carbon dioxide (CO₂), carbon monoxide (CO), and hydrogen (H₂).
